(19) United States
(12) Patent Application Publication
(10) Pub. No.: US 2026/0363281 A1
(43) Pub. Date: Nov. 19, 2026

(54) PRODUCING SLOWLY DIGESTIBLE AND RESISTANT STARCH WITH GLUTEN-FREE FLOURS USING MULTI-STEP HYDROTHERMAL TREATMENTS

(71) Applicant: ARCHER-DANIELS-MIDLAND COMPANY, Decatur, IL (US)

(72) Inventors: Jihong Li, Decatur, IL (US); Maaran Suntharamoorthy, Decatur, IL (US); Rhonda Witwer, Decatur, IL (US); Ali Ayoub, Decatur, IL (US)

(21) Appl. No.: 19/138,579

(22) PCT Filed: Dec. 12, 2023
(86) PCT No.: PCT/US2023/083548

§ 371 Date: Jun. 12, 2025

Related U.S. Application Data
(60) Provisional application No. 63/387,019, filed on Dec. 12, 2022.

(51) Int. Cl. A23L 7/10; A23L 5/30

(52) U.S. Cl. CPC A23L 7/198; A23L 5/30

(57) ABSTRACT

A process for increasing the amount of resistant starch and slowly digestible starch in a gluten free starch product is provided. The process includes at least a step of heating a moistened gluten free starch product having a moisture level of about 20-30% to a first temperature of from 55 to 65 °C for up to 16 hrs, and a step of heating the moistened gluten free starch product to a second temperature between 90 and 110 °C for from 1 to 6 hrs. The invention is illustrated using sorghum flour as the gluten free starch product but can be practiced with any gluten free starch product including whole or refined flours from other gluten free grains like millet and rice, from pulses such as peas, lentils and beans as well from root and tuber starches such as potato, yam, sweet potato, Jerusalem artichoke, taro and breadfruit in which starch is at least 40% of the weight of the starch product.

### BACKGROUND ART

Starches are produced by all green plants. Plant starches can be broadly categorized according to their rate and extent of digestion: rapidly digestible starches (RDS), slowly digestible starches (SDS), and resistant starches (RS). High levels of SDS and RS in starchy foods potentially provide a large and broad range of health benefits. The rate and extent of digestibility of more rapidly digestible starches can be modified toward more a more slowly digestible and more resistant character by hydrothermal treatment. An annealing process typically involves heating starch in an aqueous slurry to a temperature below the gelatinization temperature, normally at 40-65 °C for up to 72 hrs. In a heat moisture treatment process, starch is typically heated to over 100 °C for two or more hours at a low moisture content, normally below 35% by weight. Both methodologies used individually or in combination are effective to a degree. However, high RS gluten free flours (i.e, a flour where at least 15% of the starch content by weight can be characterized as RS) or a starch alone with at least 15% RS are not known to be commercially available.

CN109457003 discloses an enzymatic production method for making resistant sorghum starch with high yield. The preparation method combines a high temperature-resistant alpha-amylase and pullulanase to partially hydrolyze and debranch the starch forming maltooligosaccharides that are converted into the isomaltooligosaccharides by the glucosidetransferase and the pullulanase. By adding micromolecular polyphenol, the activity of alpha-amylase is partially inhibited, the selectivity of enzyme hydrolysis site of amylase is improved, the generation of oligosaccharide with DP (degree of polymerizing) value smaller than or equal to 10 is reduced, the generation of medium-chain glucan is improved, the generation of small-molecular weight digestible saccharide byproducts is reduced, and the generation amount of resistant starch is improved.

CN102190737 discloses a method for preparing resistant starch by simultaneously adopting crosslinking and heat-moisture treatment, which comprises regulating the pH value of a 30 to 45 weight percent starch slurry at a temperature between 25 and 50 degrees Celsius to be in the range of 10.5-12.5, then adding sodium trimetaphosphate/sodium tripolyphosphate in an amount which is 0.2 to 12 percent based on the weight of the dry basis of starch, holding the slurry under these conditions for from 30 to 240 minutes, then removing water and performing heat-moisture treatment at a temperature of between 100 and 140 °C for 1 to 72 hours in a heat-moisture reactor; and finally washing, drying, crushing and sieving to obtain a product. The prepared product is described as a resistant starch product that can serve as a functional food material and biochemical medicine carrier.

U.S. Pat. No. 6,468,355 discloses a boiling-stable granular resistant starch product which may comprise over 60 percent resistant starch as determined by the total dietary fiber (TDF) method. The starch is made by subjecting a starch source to acid hydrolysis, followed by a hydrothermal treatment which is preferably heat-moisture treatment. The boiling-stable granular resistant starch product may be used in formulating low-fat, high-fiber food products, as a tableting aid, and as an inhibitor of excessive ice crystal formation in frozen products.

CN109588695 discloses a preparation method for making a RS5 wheat resistant starch. The preparation method comprises: firstly, performing de-branching treatment on wheat starch through pullulanase to obtain de-branched wheat starch; then compounding the de-branched wheat starch and glycerin monostearate; finally improving the content of the wheat resistant starch through heat-moisture treatment. The content of the resistant starch in wheat starch is more than 70 percent.

CN107245111 discloses a processing method for increasing resistant starch in rice by treatment with sodium hydroxide, which is used for removing lipid components from rice to obtain a coarse rice starch with high purity; passes through crosslinking of magnetic chitosan is carried out with glutaraldehyde so as to form a magnetic adsorptive material to immobilize pullulanase, so that enzyme utilization efficiency and using efficiency are increased. The process increases the amount of resistant starch in the product.

KR20190000966 discloses a method for producing common corn starch with improved cold-water thickening and slow digestion properties through moisture-heat treatment and alcoholic-alkaline double deformation treatment. In the disclosed method, an alcohol-alkaline method is applied to a sample having high resistance starch subjected to a heat treatment to develop starch having both a high cold-water viscosity and a cold-water solubility with a slowly digestible starch (SDS) content higher than that of commercially available general corn starch. The starch prepared according to the disclosed method has increased viscosity and solubility even in cold water.

U.S. Pat. No. 5,849,090 discloses method of producing a granular resistant starch comprising the steps of heating a granular native starch to swell but not rupture the starch granules, debranching the starch with a debranching enzyme, treating the starch to retrograde the amylose therein, optionally annealing the starch and optionally drying the product. Granular resistant starch produced by this method.

KR20020070671 discloses an RS4 type crosslinked resistant starch with an increased yield of resistant starch by annealing raw starch and adding a surfactant. The crosslinked resistant starch is produced by a process comprising the steps of: controlling the concentration of the raw starch to be 10-50 percent and annealing at 10-70 °C for 1-48 hours; shaking the annealed starch in a constant temperature water tank with 30-50 °C for 5-20 minutes and adding 0.1-0.5 wt percent of the surfactant and reacting for 1-16 hours: adding 5-20 wt percent of sodium sulfate and mixing and shaking for 10-40 minutes and adding 10-20 wt percent of a crosslinking agent such as sodium trimetaphosphate and sodium tripolyphosphate and shaking for 10-30 minutes and adjusting pH to be 10.5-11.5 with IN NaOH and reacting for 3-5 hours; neutralizing the resultant starch with HCl and washing with water four times or more and drying in an oven with 30-50 °C and performing abrasion.

CN104247914 discloses a preparation method for making a flour rich in high resistant starch, that includes the steps: adding water into starch to fully penetrate into the starch to obtain agglomerated starch; removing excess water from the agglomerated starch; continuing drying until the water content reaches a set value; balancing the agglomerated starch with the water content being the set value to make the water distribution homogenized; placing the balanced starch in a constant temperature oven for heat treatment, then cooling, adding ethanol into the starch obtained by drying, grinding and sieving to obtain heat-moisture treated starch; adding dry flour into the heat-moisture treated starch, fully mixing, and standing to obtain the flour rich in high resistant starch.

U.S. Pat. No. 6,013,299 discloses making an enzyme resistant starch type III (RS3) which has a melting point or endothermic peak of at least about 140 °C as determined by differential scanning calorimetry (DSC) in yields of at least about 25 percent by weight, based upon the weight of the original starch ingredient. A gelatinization stage, nucleation/propagation stage, and preferably a heat-treatment stage are used to produce reduced calorie starch-based compositions which contain the enzyme resistant starch type III (RS3). The enzyme resistant starch is produced using crystal nucleation and propagation temperatures that avoid substantial production of lower melting amylopectin crystals. The nucleating temperature used is above the melting point of amylopectin crystals. The high melting point of the enzyme resistant starch, as measured by DSC, permits its use in baked good formulations without substantial loss of enzyme resistance upon baking.

CN106473147A discloses a method for preparing pure purple Chinese yam resistant starch. The preparation includes multi-steps: starch preparation (yam root washing, peeling, cutting, pulping, filtration, precipitation, repeated washing and centrifugation, ethanol washing, vacuuming and drying, grinding); cooking and debranching using pullulanase enzyme in slurry; starch retrogradation/aging with cooking and cooling; enzymatic hydrolysis using alpha-amylase and glucoamyloase; ethanol washing, vacuum drying and grinding. The yam resistant starch contains <5.96% RDS, <7.35% SDS and 86.69% RS.

CN107299125A discloses a similar method to CN106473147A above for RS preparation using waxy type of corn starch. Waxy corn starch slurry was cooked, alpha-amylase and pullulanase hydrolyzed, water and ethanol washed, dried and ground. The product contained >85% RS.

US2014093632A1 a method of making a chemically modified starch in a dry state.

There remains a need in the art to develop methods of making a clean label starch product that has increased resistant starch and slowly digestible starch content, that does not involve the expense of enzymes, that does not rely on chemical treatments that artificially crosslink starch and which is easy to scale to commercial production levels.

### SUMMARY OF THE INVENTION

The present disclosure provides a two-step semi-dry process that involves heat treatment of a starch product in a first step at a sub-gelatinization temperature (below 67 °C), most typically between 55 and 65 °C, and with maintaining a low moisture level of about 20-30% for up to 16 hours, followed by a second step involving a high-temperature treatment at from 90 and 110 °C for from 1 to 6 hours. The entire treatment, including mixing, heating, cooling, and drying, can preferably be accomplished in one vessel. The resultant flour contains a high level of slowly digestible starch (SDS) and resistant starch (RS) (over 70% by mass of the total starch, combined, in these two categories).

The method results in an increase in both the resistant starch fraction and slowly digestible starch fraction in the starch product. In various embodiments the invention results in at least a twofold, threefold or even fourfold increase in the amount of resistant starch in the starch product compared to the untreated starch product. In some embodiments the resistant starch fraction is least 20% of the total starch in the product. In other embodiments the resistant starch fraction in the starch product is at least 30% of the total starch in the product. In certain desirable embodiments the combination of resistant starch and slowly digestible starch in the starch product is at least 65% by mass of the total starch in the product.

The disclosure is exemplified using sorghum flour but can be practiced with any gluten free starch product, including refined starches or whole or refined flours from gluten free grains like sorghum, millet, and rice, from pulses such peas, lentils and beans, as well a root and tuber starches such as potato, yam, sweet potato, Jerusalem artichoke, taro, and breadfruit provided that starch is at least 40% of the weight of the starch product.

In another aspect the invention provides a starch product prepared according to the foregoing methods. The starch product is a gluten free starch product wherein a resistant starch fraction in the starch product comprises at last 15% of the starch in the product and the starch lacks chemical crosslinking or enzymatic rearrangement of glycosidic linkages. In some embodiments the resistant starch fraction in the starch product is at least 20% of the total starch in the product. In other embodiments, the resistant starch fraction in the starch product is at least 30% of the total starch in the product. In certain embodiments the gluten free starch product is a grain flour. In an exemplary embodiment the gluten free starch product is a sorghum flour. In other embodiments the gluten free starch product may be a starch or flour from millet, rice, from a pulse such as pea, lentil or bean or a be a root tuber starch such as potato, yam, sweet potato, Jerusalem artichoke, taro, and breadfruit provided that starch is at least 60% of the weight of the starch product.

### BRIEF DESCRIPTION OF THE DRAWINGS

FIG. 1 shows the nutritional fraction profile of a sorghum flour treated according to the present invention in terms of rapidly digestible starch (RDS), slowly digestible starch (SDS), and resistant starch (RS) content.

FIG. 2 shows flour rapid visco analyser (RVA) pasting curves starch in the sorghum flours initially adjusted to 20% (2A) or 25% (2B) moisture content followed by heating to 60 °C for 16 h and then 100 °C for various times.

FIG. 3 shows the whiteness level of starch in the sorghum flour treated according to the present invention.

### DETAILED DESCRIPTION OF THE INVENTION

“Starch product” as used herein is a composition wherein at least 40% of the weight of the composition is starch. Examples include, a refined grain flour, a whole grain flour, refined starch, tuber starch (potato), or root starch (tapioca), and pulse starches or flour (e.g., pea starch).

“Whiteness measurement” is a measure of the amount of color in a product on a scale of 0-100 where 0 is completely black and 100 is a completely white.

A novel process technology was developed for physical treatment (hydrothermal) of gluten-free flour to prepare a flour with increased amounts of slowly digestible starch (SDS) and resistant starch (RS) for healthy food applications. The invented technology involves a plurality of hydrothermal treatments on refined/whole gluten-free grain flours at benchtop and pilot scales that can readily scaled up and commercialized with commercially available equipment. The process comprises at least two essential steps but can accommodate other steps prior to, intervening within, or added after the two essential steps. The first essential step is obtaining a starch product with a moisture content of 20%-30% and heating it to a first temperature between 55-65 °C for a period of 4 to 20 hrs. The second essential step is heating to a second temperature of 90-110 °C for a period of 1 to 6 hrs. In each, the heating may be done in an open vessel providing only atmospheric pressure, or in a closed vessel where the pressure may be up to 140 kPa, gauge (20 psig) so there is no loss of moisture in the starch product. In most applications the treated starch product is further dried, most typically under a vacuum pressure which may be up to 60 kPa.

Sorghum is one of the major staple cereal crops in the world and its grain has been used in many food and beverage products such as a source of sweetener in sorghum syrups and molasses, alcoholic beverages and cereal-based baked products. Sorghum grain is gluten free and a good starting source of slowly digestible and resistant starch due to its unique structure of starch-protein matrix in kernel endosperm. It has great potential to be used as a healthy food ingredient in many food products. A starch product can be made from sorghum by the present invention where the resistant starch fraction in the starch product is at least 15% of the total starch in the product.

White sorghum flour (refined or whole) with a starch content of 60-85% was used for technology development. Sorghum flour was treated in a commercial scalable mixer through mixing, heating, and drying at a semi-dry solid state. Flour was thoroughly mixed with water at the moisture level of 20-30%, then the mixture was heated to 60 °C with agitation for 16 hrs, then the moisture of the mixture was adjusted to 20% by vacuum drying and the temperature was raised to 100 °C with continuous agitation for various times up to 6 hrs. The treated flour was finally vacuum dried to a moisture level of 10-12% and passed through a 40-mesh sieve.

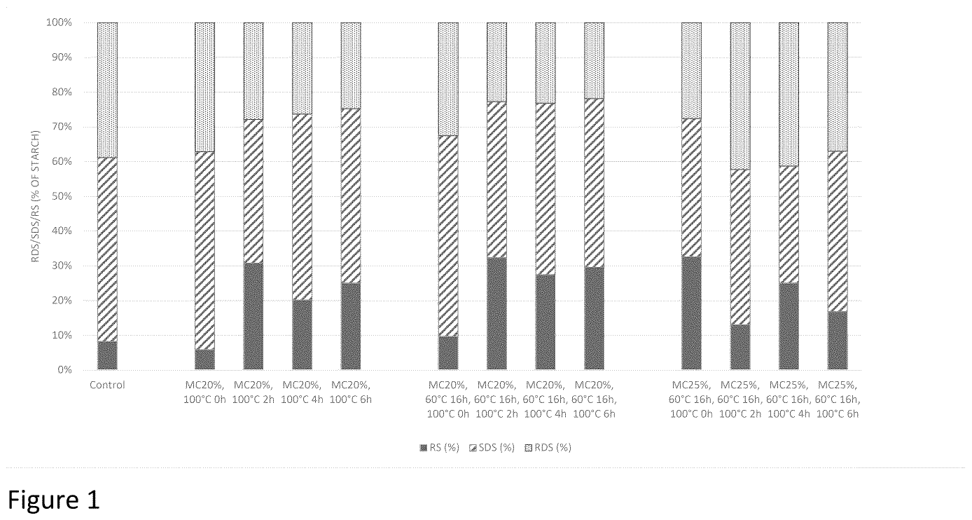

FIG. 1 shows the starch nutritional fraction profile of treated refined white sorghum flour at a moisture level (MC) of 20-25%, heated at 60 °C for 16 hrs and/or 100 °C for various times ranging up to 6 hrs. The RS in the white sorghum flour increased from 8% in the control to 32% (by mass on a total starch basis) and the total of SDS and RS contents increased from 61% to 78% at MC 20%, through processing at 60 °C for 16 hrs and 100 °C for 2 hrs.

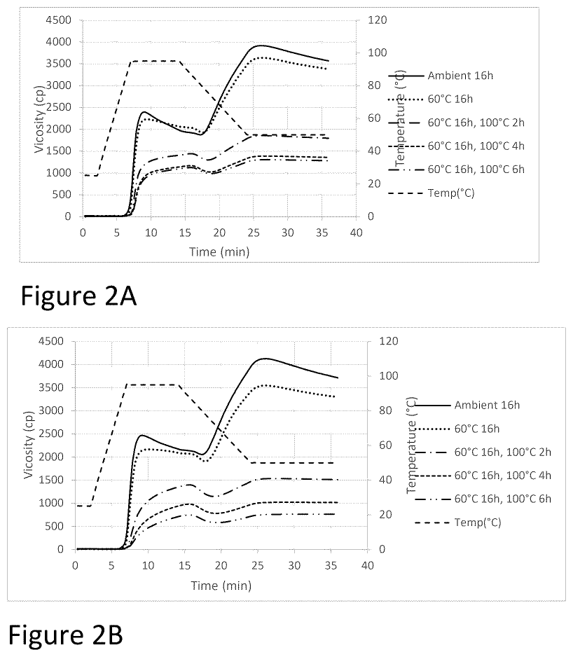

The foregoing treatment also altered the functional properties of the flour. As shown in FIG. 2, the peak viscosity was reduced, and the resultant heating-cooling curve indicates a reduction of water absorption, low peak and final viscosity and thus, increased stability during the cooling phase.

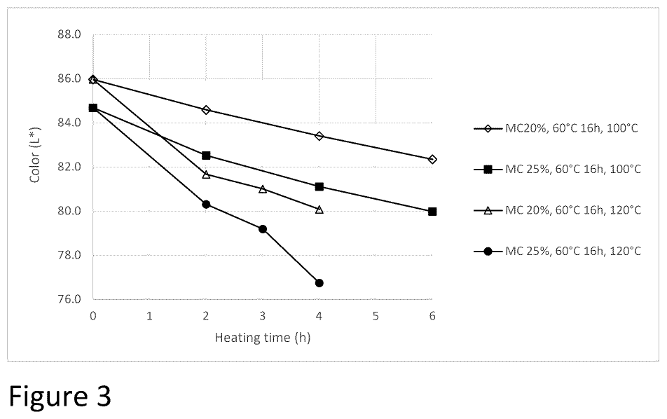

The inventive hydrothermal treatment method as applied to the refined white sorghum flour affected the flour's color. As shown in FIG. 3, treatment at higher temperature and for longer times produced darker colors compared to those at lower temperature and shorter treatment times. In general, the treatment at MS 20%, heated at 60 °C for 16 hrs and then heated at 100 °C for 2 hrs showed optimal conditions for the highest SDS and RS production with retention of a whiteness level of at least 80.

The inventive hydrothermal treatment method had consistent outcomes in the SDS/RS content of a treated flour between benchtop scale amounts (150 g/batch) and pilot scale amounts (20 lbs/batch) as shown in Table 1, indicating the process is readily scalable to commercial levels of production.

TABLE 1
The contents of SDS and RS in control
and treated white sorghum flours.

| | RDS | SDS | RS |
|---|---|---|---|
| Sample | % of starch | | |
| Control | 36.9 | 61.5 | 1.6 |
| Benchtop | 22.8 | 44.8 | 32.3 |
| Pilot scale (5 lbs) | 26.6 | 43.1 | 30.3 |
| Pilot scale (20 lbs) | 23.5 | 44.5 | 32.0 |

The hydrothermally treated flour was incorporated in some baked products to evaluate product stability during the baking process. Baking tests showed that RS were largely retained as dietary fiber in low moisture baked product as shown in Table 2. Flour 1 was heated to 60 °C for 16 hrs then to 100 °C for 2 hrs. Flour 2 was heated to 60 °C for16 hrs, without the second treatment step at 100 °C. Sugar cookies made with treated flour 1 contained 5.3 times higher RS (18.5% vs 3.5%) and 2.1 times higher TDF than control cookie from flour 2 (27.4% vs 12.9%).

TABLE 2
The contents of RS and total dietary fiber (TDF) in sugar cookies.

| | RS | TDF |
|---|---|---|
| Cookie | % of starch | % of flour |
| Control | 3.5 | 12.9 |
| Treated flour 1 | 18.5 | 27.4 |
| Treated flour 2 | 9.4 | 16.5 |

The foregoing examples have been produced using sorghum flour, but similar results would be obtained with any gluten free starch product, including refined starches or whole or refined flours from gluten free grains like sorghum, millet, and rice, from pulses such as peas, lentils and beans as well a root and tuber starches such as tapioca, potato, yam, sweet potato, Jerusalem artichoke, taro, and breadfruit provided that starch is at least 40% of the weight of the starch product.

1. A method for increasing the amount of resistant starch in a starch product, comprising obtaining a moistened starch product having a moisture content of from 20 to 30 percent by weight, heating the moistened starch product to a first temperature of from 55 to 65 °C for a period of from 4 to 20 hrs, and heating the moistened starch product to a second temperature of from 90 to 110 °C for a period of from 1 to 6 hrs.

2. The method of claim 1, wherein the moistened starch product is selected from the group consisting of a gluten free flour or starch, a tuber flour or starch, a grain flour or starch and a pulse flour or starch.

3. The method of claim 2, wherein the moistened starch product comprises one or more of a starch or flour from millet, rice or tapioca or of a tuber starch selected from the group consisting of potato, yam, sweet potato, Jerusalem artichoke, taro, and breadfruit, or a starch of flour from a pulse, and further in which starch is at least 40% of the weight of the moistened starch product.

4. The method of claim 1, wherein the resistant starch fraction in the moistened starch product before the first and second heating steps is at least 15% by mass of the total starch mass in the product.

5. The method of claim 4, wherein the resistant starch fraction in the moistened starch product is at least 20% by mass of the total starch mass in the product.

6. The method of claim 5, wherein the resistant starch fraction in the moistened starch product is at least 30% by mass of the total starch mass in the product.

7. The method of claim 1, wherein the combination of resistant starch and slowly digestible starch in the moistened starch product before the first and second heating steps is at least 65% by mass of the total starch mass in the product.

8. The method of claim 1, wherein the moistened starch product is sorghum flour.

9. A starch product produced by the method of claim 1.
